(19) United States
(12) Patent Application Publication
(10) Pub. No.: US 2009/0129089 A1
(43) Pub. Date: May 21, 2009

(54) Decorative Display Apparatus

(76) Inventor: Patricia LaVallee, Ft. Lauderdale, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/271,104

(22) Filed: Nov. 14, 2008

Related U.S. Application Data
(60) Provisional application No. 61/003,480, filed on Nov. 16, 2007.

(51) Int. Cl. F21V 21/00; A47G 33/00

(52) U.S. Cl. 362/249.16; 428/7; 362/249.06

(57) ABSTRACT

A decorative display apparatus having a front support member and a rear support member held parallel to each other by at least one stabilization body. The front support member may comprise one or more first apertures and the rear support member may comprise an equal number of second apertures axially aligned with the respective first apertures. In a preferred embodiment, illumination housings extending through the first and second apertures may comprise recyclable items to provide an environmentally friendly alternative for decorative displays. The front and rear support members may further comprise either two or more components removably connected to each other and/or one or more fold lines thereby allowing for compact storage when not in use. The present invention may further comprise lights disposed within the illumination housings, creative artistic embellishments, and features allowing consumers to hang decorative items from the components of the decorative display apparatus.

### CROSS REFERENCE TO RELATED APPLICATIONS

This application claims the benefit of provisional patent application Ser. No. 61/003,480, filed with the USPTO on Nov. 16, 2007, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to a decorative display apparatus, more specifically, the present invention relates to an ornamental and decorative racking system for recyclable and/or non-recyclable items.

2. Background Art

Throughout history, humans have sought to enhance their surroundings by the use of decorative items. Such items have included diverse elements such as wall paintings, tiles, tapestries and two-dimensional art, to name a few. In many instances, such decorative elements become a relatively permanent part of the environment in which they are placed, remaining on display for years on end. In contrast to these long-term decorations, some decorative items are intended to be of a more transient nature. One example is the use of fresh cut flowers that have a display life of only a few days.

Decorative displays and lighting are known for use at both homes and businesses to achieve a desired architectural or visual effect. Decorative light strings are one type of well known decorative system that is particularly popular for use around the fall and wintertime holidays. Many individuals believe that there is nothing like a cheerful string of lights to foster the holiday spirit. Bright, twinkling, or flashing lights and decorative ornamental displays are a few of the joys and traditions of the holiday season. When displayed at a home, building, or other structure, lighting systems and ornamental displays are known for providing a holiday visual effect akin to a decorated gingerbread house, and therefore are desirable to traditionalist holiday decorators. Other alternatives, such as rope lights, are commonly known and used in the art. Rope lights contain the light emitting components within a flexible conduit or “rope” sheath providing for snag-free installation and removal.

In recent years there has been an increase in the use of lights, lighting and various displays for decorating on various special occasions and holidays including but limited to Christmas, Thanksgiving, Easter, Valentine's Day, Fourth of July, Halloween, New Year's Eve, St. Patrick's Day, Memorial Day, Labor Day, advent of spring, fall harvest, the birth of a child, an anniversary, a birthday, and the like. Christmas is one of the holidays that bring out a large amount of decorations both inside and outside of various homes, offices, office buildings, businesses, parks, malls, and the like.

Modern decorations are also replete with flat, two-dimensional, color printed and painted placard-type forms which are hung or erected in the yard by means of a stake or prop attached to the form. These forms are typically made from wood, plastic, cardboard, corrugated materials, and the like. More expensive versions may comprise molded plastic with openings formed therein to hold lights. Forms without lights may be illuminated at night with separate flood or spot lights. Such decorations may provide depictions of characters, objects, text, and/or other subject matter. Such portrayals may include Santa and his reindeer, snowmen, scarecrows, and the like. Common non-holiday decorative displays may include but are not limited to various animal depictions such as those often seen placed about a garden setting or landscaping bed.

U.S. Pat. No. 5,534,315 to Witte discloses a predetermined plurality of retainers being inserted into corresponding apertures of a first sheet and a second sheet to maintain the first and second sheets in a rigid and parallel relationship to form a free-standing decorative art form. One embodiment includes a predetermined art work pattern of colors on the front of the first sheet. Another embodiment includes a predetermined art work pattern of colors on the back of the second sheet as well as on the front of the first sheet. Another embodiment includes a lamp assembly in each retainer with the lamp assembly oriented to display light at the front of the decorative art form.

Other decorative forms include wire forms in which the wire or wires form the profile shape of the object and electrical wiring with lights is wrapped around or fastened to the wire form to illuminate the profile at night. During daylight hours when the illuminating lights are off, the nature of the object depicted by the wire form can be obscure and non-descriptive.

Such prior art may be exemplified by U.S. Pat. No. 5,955,156 to Hermanson which discloses lighted display device includes a sculpted frame formed of thin wire or tubing. The frame outlines a character or an object and has one or more closed portions defined by the wire or tubing enclosing an area or partially enclosing an area. The display further includes a string of lights disposed along selected portions of the frame, and at least one translucent panel disposed in the closed portions or partially-closed portions of the frame.

Other decorative forms include three-dimensional forms which are molded of plastic with the various colors being formed in the plastic or painted on the surface of the plastic. These type forms are provided with a light inside the form or are illuminated by a spot or flood light directed at the exterior of the form.

Such prior art may be exemplified by U.S. Pat. No. 6,284,330 to Hermanson which discloses an expandable three-dimensional display device that is provided with a cover and a support post at least partially disposed within the cover. The display device includes a mechanism associated with the cover and support post that is operable alternately to expand the cover to an enlarged configuration about the post to provide a three-dimensional display and collapse the covers to a collapsed configuration. A light is mounted within the cover to illuminate it. U.S. Pat. No. 7,086,757 to Wang discloses an improved formed lighting fixture having a frame, a plurality of bulbs, and a refracting layer, in which the frame is formed by gathering a plurality of rods and profiled in a specific contour, the bulbs are installed on the frame to serve as lighting ornaments, and the rod frame is coated with a refracting layer of a transparent material. Additionally, U.S. Pat. No. 7,303,313 to Ma discloses a Christmas decoration assembly includes a plurality of parts overlapped to each other and each part is composed of rods. The parts have first connection devices on lower edges thereof and a second connection device on an upper edge thereof. The first and second connection devices connect the parts to each other. Each part includes rings connected thereto so as to position bulbs and a plurality of wires is wrapped to the parts and plastic beads or ribbons are attached to the wires.

The present invention relates to decorative display apparatus and particularly to an apparatus which may simulate the appearance of a wide variety of objects pertaining to any subject matter. The present invention is capable of year round utility, and need not be limited to the holiday season and/or holiday related subject matter.

The present invention provides a decorative display apparatus which is uniquely functional as it allows a consumer to turn recyclable and/or non-recyclable items into an attractive decorative display apparatus, with optional lights and/or other embellishments.

The present invention as claimed is intended to provide decorative art forms that eliminate or reduce many of the prior art deficiencies which include a cheap appearance, lack of a quality appearance in both daylight and nighttime, and lack of weather durability and survival. Many of the prior art forms are difficult and expensive to transport because of their size and shape. Furthermore, many of the prior art forms lack details to provide a pleasing appearance and a sharp image and many do not display well when the device is not illuminated by lights.

### BRIEF DESCRIPTION OF THE DRAWINGS

A better understanding of the present invention will be realized from the detailed description that follows, taken in conjunction with the accompanying drawings, in which:

FIG. 1 depicts a side view of an embodiment of a decorative display apparatus of the present invention wherein each of the plurality of first apertures within the front support member has a diameter that is generally equal to that of each of the corresponding plurality of second apertures of the rear support member.

FIG. 2 depicts a side view of an embodiment of a decorative display apparatus of the present invention wherein each of the plurality of first apertures within the front support member has a diameter that is greater than that of each of the corresponding plurality of second apertures of the rear support member.

FIG. 3 depicts a front view of an embodiment of a decorative display apparatus of the present invention wherein the front support member does not closely follow the outer shape of the plurality of first apertures and the front support member is constructed in a loosely packed configuration.

FIG. 4 depicts a front view of an embodiment of a decorative display apparatus of the present invention wherein the front support member closely follows the outer shape of the plurality of first apertures and the front support member is constructed in a densely packed configuration.

FIG. 5 depicts a front view of an embodiment of a decorative display apparatus of the present invention wherein the first side of the front support member comprises an artistic design having a plurality of first apertures disposed there through.

FIG. 6 depicts a rear view of an embodiment of a decorative display apparatus of the present invention wherein the second side of the rear support member comprises an exposed lighting configuration attached thereto.

FIG. 7 depicts a front view of an embodiment of a decorative display apparatus of the present invention wherein the front support member comprises two or more component members and one or more fold lines.

### BRIEF SUMMARY OF THE INVENTION

In accordance with one embodiment, a decorative display apparatus comprising a front support member having a first side and a second side, the front support member exists generally in a first plane and further comprises a plurality of first apertures extending through the front support member, a rear support member having a first side and a second side, the rear support member exists generally in a second plane and further comprises a plurality of second apertures extending through the rear support member, wherein the plurality of first apertures are equal in number to the plurality of second apertures, and at least one stabilization body for maintaining the first plane of the front support member in a position parallel to the second plane of the rear support member, wherein the second side of the first support member is disposed in a position facing the first side of the second support member and each of the plurality of second apertures is disposed in axial alignment, respectively, with one of the plurality of first apertures.

The scope of the present invention further includes embodiments that may comprise one or more elements including a base member for maintaining the decorative display apparatus in a generally upright position, wherein the base member is in communication with both a lower portion of the front support member and a lower portion of the rear support member, at least one fastener member for securing the at least one stabilization body to the front support member or the rear support member, a plurality of illumination housings disposed within and extending between the plurality of first apertures and the plurality of second apertures, each of the plurality of illumination housings comprising only one point of entry into each of the plurality of illumination housings wherein the one point of entry is disposed adjacent the second surface of the rear support member allowing for access through one of the plurality of second apertures to the first side of the rear support member, and wherein each of the plurality of illumination housings contains at least one light source entering said illumination housing through the one point of entry.

### DETAILED DESCRIPTION OF THE INVENTION

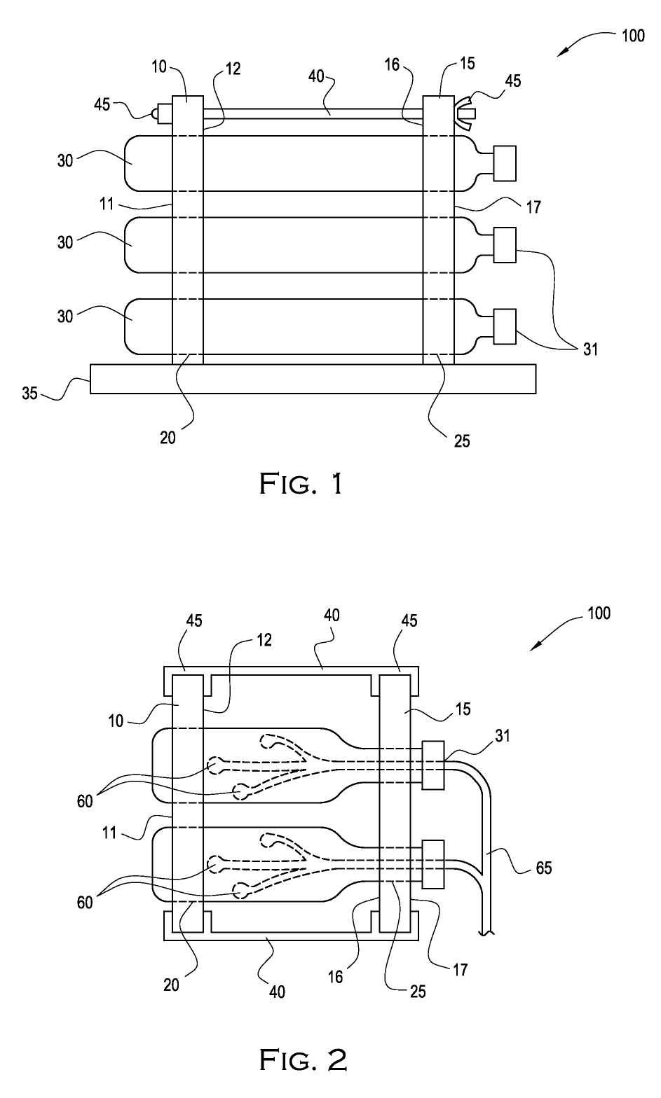

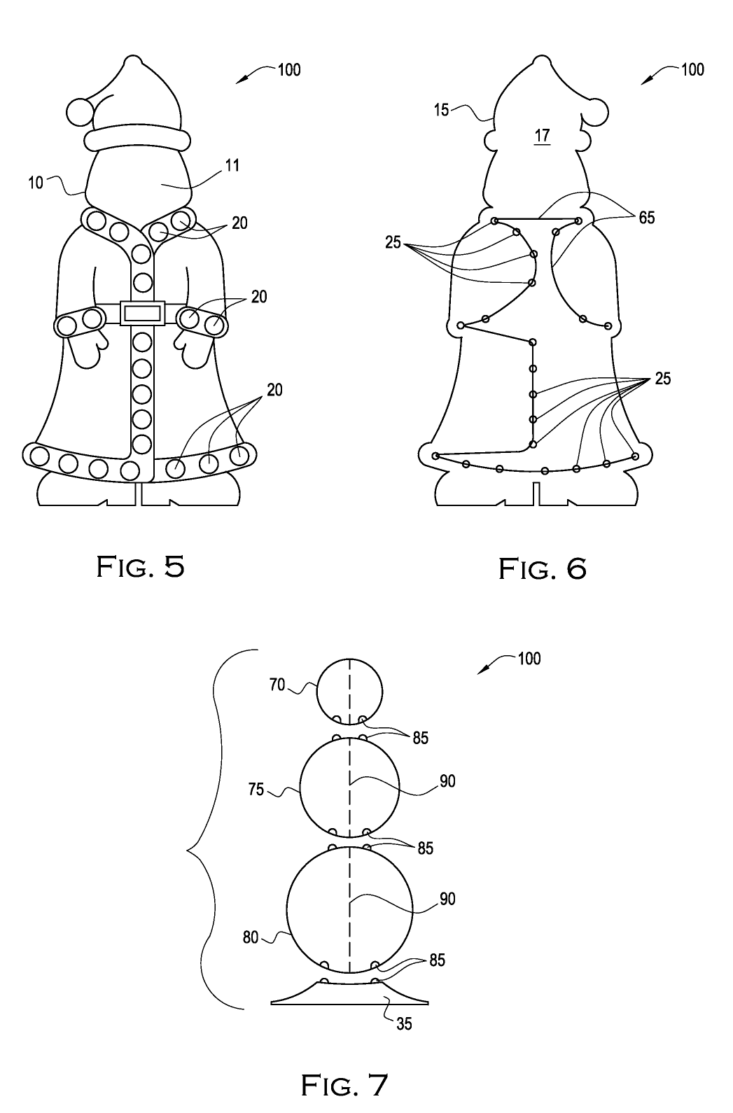

In accordance with the Figures, and particularly FIG. 1, a decorative display apparatus 100 is described. The present invention generally provides for an apparatus 100 that may turn either recyclable or non-recyclable items into indoor and outdoor decorative displays for both everyday and holiday use. FIG. 1 depicts one exemplary embodiment of the subject decorative display apparatus 100. Such an embodiment may comprise a front support member 10 having a first side 11, a second side 12, and a plurality of first apertures 20 (see FIGS. 1-5). The apparatus 100 may further comprise a rear support member 15 having a first side 16, a second side 17, and a plurality of second apertures 25 (see FIGS. 1, 2, and 6). The front support member 10 and the rear support member 15 may be maintained in a parallel configuration by means of at least one stabilization body 40, wherein attachment of the at least one stabilization body 40 may be facilitated by at least one fastener member 45. To allow for nighttime displays, a plurality of illumination housings 30 may be disposed within and extending between both the plurality of first apertures 20 and the plurality of second apertures 25.

The front support member 10 and rear support member 15 of the decorative display apparatus 100 of the present invention may be constructed in a wide variety of shapes including, but not limited to: Christmas trees, snowmen, presents, reindeer, skaters, ornaments, menorahs, and the like for holidays; hearts, candy, and the like for Valentine's Day; eggs, rabbits, baskets, and the like for Easter; flags and the like for patriotic holidays; pumpkins, ghosts, candy, and the like for Halloween; pumpkins, turkeys, trees, pilgrims, and the like for Thanksgiving; every day items such as butterflies, lady bugs, cars, trucks, dinosaurs, and the like for children; “Word” or text displays such as Happy Holidays, New Baby, Happy Thanksgiving, and the like; and every day items such as birds, martini glasses, cars, and the like for adults. Alternatively, the front support member 10 and rear support member 15 of the decorative display apparatus 100 of the present invention may comprise a plurality of modular units that allow consumers to create their own uniquely shaped front support members 10 and rear support members 15, respectively.

The front support means 10 lies generally in a first plane and the rear support member 15 lies generally in a second plane. As depicted in FIG. 1, at least one stabilization body 40 may communicate with both the front support member 10 and the rear support member 15 thereby maintaining each support member 10,15 in a parallel relationship to the other. Two or more stabilization bodies 40 may be used to provide greater structural stability as necessary and/or if an optional base member 35 is not utilized. At least one fastener member 45 may be used to affix the at least one stabilization body 40 to either or both the front support member 10 and the rear support member 15. At least one fastener member 45 may be used at each junction between the at least one stabilization body 40 and each support member 10,15. The scope of the present invention may include the use of any fastening members 45 know within the art including but not limited to nuts, bolts, screws, rivets, wing nuts, clips, clasps, and the like. As illustrated in FIG. 2, each stabilization body 40 may have one or more fastener member 45 structures integrally formed upon the stabilization body 40.

FIGS. 1-2 further depict a plurality of illumination housings 30 which may be disposed within respective first apertures 20 and second apertures 25 that are in axial alignment. Each of the plurality of illumination housings 30 may comprise only one point of entry 31 therein. In a preferred embodiment, one point of entry 31 is disposed adjacent the second side 17 of the rear support member 15 thereby allowing a lighting configuration 65 access within the illumination housing 30. Illumination housings 30 may comprise a variety of materials including but not limited to any materials known within the art such as plastic, glass, metal, paper, and the like. Light may either pass through the illumination housing 30 material, such as may be the case with materials such as plastic and glass, or light may pass through a plurality of holes cut through metal materials and the like. In a preferred embodiment, the illumination housings 30 may comprise recyclable or non-recyclable materials such as plastic water bottles, glass bottles, cans, plastic containers, and the like. The use of recyclable materials provides a consumer with a sense of well being for utilizing recyclable materials in a useful manner as opposed to adding further waste to global landfills.

The dimensions of both the plurality of first apertures 20 and the plurality of second apertures 25 are fully customizable within the scope of the present invention. The size, shape, and dimensions of the selected illumination housings 30 need not be restricted, and the first apertures 20 and second aperture 25 may be constructed to conform to any number of configurations. FIGS. 1-6 generally illustrated a preferred embodiment of illumination housings 30 having circular cross sections and therefore circular first apertures 20 and circular second apertures 25 are depicted. However, potential illumination housing 30 shapes and cross sections are limitless and may include but are not limited to circles, ovals, triangles, squares, rectangles, hexagons, octagons, and the like. Likewise, the first apertures 20 and second aperture 25 may comprise any number of limitless shapes preferably selected to most properly support the illumination housing 30 by closely conforming to the outer circumference or periphery of the illumination housing 30.

As illustrated in FIGS. 1-2, each of the plurality of first apertures 20 is axially aligned with a respective second aperture 25 from the plurality of second apertures 25. FIG. 1 depicts a plurality of first apertures 20 having the same dimensions as the plurality of second apertures 25 given the continuity of the illumination housing 30 disposed there through. In an alternative embodiment, the plurality of second apertures 25 may be of a greater or lesser dimension (see FIG. 2) as compared to the dimension of the plurality of first apertures 20. FIG. 2 depicts a plurality of second apertures 25 of reduced dimension that conform to the narrower “neck” portion of a preferred illumination housing 30, such as a plastic water bottle. In use, both the plurality of first apertures 20 and plurality of second apertures 25 may comprise an endless variety of shapes and sizes to properly accommodate the desired illumination housings 30 being used.

The plurality of first apertures 20 and the plurality of second apertures 25 may serve to retain the plurality of illumination housings 30 in and of themselves, but further structural assistance may be provided. In one embodiment, a resilient material may be disposed about the inner circumference of either or both the plurality of first apertures 20 and the plurality of second apertures 25. Such resilient material may beneficially provide a holding force and may take any form known within the art including but not limited to resilient bristles extending into the respective apertures 20,25; gripping material such as a rubberized layer conforming to the inner circumference of the respective apertures 20,25; a plastic or rubberized sheet having one or more slits therein disposed across the totality of each respective aperture 20,25 through which the illumination housing 30 may be extended, and the like. Such slits or flexible flaps are typically used, for example, in vehicle drink holders. Use of such additional resilient material may further allow the respective apertures 20,25 to accommodate a variety of sized and/or dimensioned illumination housings 30.

As depicted in FIGS. 2 and 6, the decorative display apparatus 100 of the present invention may further comprise a lighting configuration 65 that provides at least one light source 60 to the interior of each of the plurality of illumination housings 30. The at least one light source 60 may comprise any light source known within the art including but not limited to light emitting diodes, rope lights, string lights, and the like. FIG. 2 illustrates at least one light source 60 being disposed within an illumination housing 30 by means of the one point of entry 31 for each illumination housing 30. In a preferred embodiment and as depicted in FIG. 2, the one point of entry 31 is adjacent the second side 17 of the rear support member 15. By its extension into the illumination housing 30, the at least one light source 60 passes through the respective second aperture 25 of the rear support member 15. In this manner, the portion of the illumination housing 30 visible through the front support member 10 may be illuminated to provide a lighted decorative display 100 as well as added consumer enjoyment.

Additionally, a light source retention means may be used at the one point of entry 31 for the plurality of illumination housings 30. In both structure and function, the light source retention means may be highly similar to the resilient material that may be incorporated onto the first apertures 20 and the second apertures 25. The light source retention means may comprise any form known within the art including but not limited to caps, plugs, bristles, flaps, and the like. FIG. 2 depicts a cap over the one point of entry 31 of the illumination housing 30. The cap or light source retention means may attach to the illumination housing 30 in any manner known within the art. In use, such a cap may comprise one or more slits, flaps, or pieces of resilient material through which the at least one light source 60 may extend. The specific structure or possible friction material comprising the retention means may assist in preventing accidental removal of the at least one light source 60 from the illumination housing 30.

As depicted in FIGS. 1, 3, 4, and 7, the decorative display apparatus 100 of the present invention may further comprise a base member 35. The base member 35 may be in physical communication with a lower portion of the front support member 10 and a lower portion of the rear support member 15. The base member 35 may assist in maintaining the decorative display apparatus 100 in a generally upright manner and may also provide added structural stability to the apparatus 100 by its communication with both the front support member 10 and rear support member 15. Base member 35 is not limited in its shape or configuration. Use of a base member 35 may not be necessary when the length of the at least one stabilization body 40 maintains the front support member 10 and rear support member 15 at a sufficient distance apart to maintain stability. As illustrated in FIG. 2, with the proper structural design and placement, the at least one stabilization body 40 may stabilize the apparatus 100 and act as a base-type structure due to its configuration and location at the lower portions of both the front support member 10 and rear support member 15. For wall displays, hangars may be provided for (not shown) on the back of the apparatus 100 to allow for the apparatus 100 to be hung on a wall. For free standing displays, a back support bracket may be provided. For yard displays, a back support bracket and/or an anchoring system for pegging the display into the ground may be provided.

As depicted in FIG. 7 (generic snowman outline), each of the present inventive front support members 10 and rear support members 15 may comprise two or more component members releasably connected therebetween. Such a releasable connection may comprise at least one structural connector 85. The present inventive apparatus 100 illustrated in FIG. 7 comprises a first component member 70, a second component member 75, and a third component member 80 with at least one structural connector 85 disposed between each of the respective component members 70,75,80. In use, each structural connector 85 may be employed to provide a secure attachment between respective releasable component members 70,75,80. When not in use, the each of the at least one structural connectors 85 may be unfastened allowing for each of the two or more component members to be stored more compactly and efficiently thereafter. Each of the at least one structural connectors 85 may include but are not limited to conventional nut, bolts, snaps, clips, interlocking structures, complimentary structures, and any other connectors or fasteners known within the art.

Alternatively or additionally as depicted in FIG. 7, the front support member 10, the rear support member 15, and any component members thereof may be collapsible and/or foldable along one or more fold lines 90 to allow for easy and efficient packaging, shipping, and/or storage when the apparatus 100 is not in use.

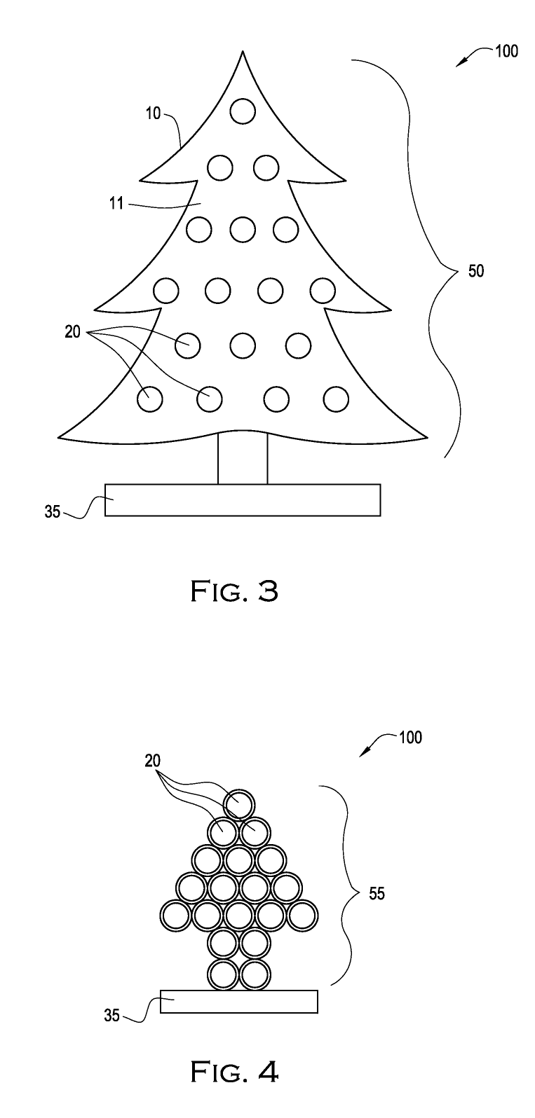

The front support member 10 and rear support member 15 of the present invention may be constructed from a near limitless variety of materials including but not limited to plastic, recyclable plastic, metal, wood, rubber, Plexiglas™, PVC, netting, and all materials known within the art. Additionally, each of the respective support members 10,15 may be constructed in either a loosely packed configuration 50 as illustrated in FIG. 3 or a densely packed configuration 55 as illustrated in FIG. 4.

As depicted in FIG. 3, the plurality of first apertures 20 may be configured in a loosely packed configuration 50, wherein the first apertures 20 are loosely arranged across the first side 11 of the front support member 10. In such an embodiment, the first side 11 of the front support member 10 becomes a much larger portion of the overall visual appearance of the decorative display apparatus 100 when viewed from the perspective of FIG. 3. In such an embodiment (and in all possible embodiments), the front rack 10 may either remain its natural color or be painted and/or colored as desired by the consumer. Due to the narrow trunk of the “tree” depicted in FIG. 3, the illustrated embodiment further comprises an optional base member 35 for added stability of the apparatus 100.

As depicted in FIG. 4, the plurality of first apertures 20 may be configured in a densely packed configuration 55, wherein the first apertures 20 are compactly arranged across the first side 11 of the front support member 10. In such an embodiment, the plurality of illumination housings 30 disposed within the plurality of first apertures 20 play the most significant role in the visual appearance of the decorative display apparatus 100 when viewed from the perspective of FIG. 4. In such a configuration the plurality of illumination housings 30 will define the overall appearance of the decorative display apparatus 100, whereas in FIG. 3 the plurality of illumination housings 30 act to supplement the appearance of the first side 11 of the front support member 10 of the apparatus 100. In a densely pack configuration 55, the front support member 10 may tightly and closely contour to the outer shape or circumference of the plurality of first apertures 20 reducing the overall visual impact of the first surface 11 of the front support member 10. In such an embodiment, the illumination housings 30 provide the primary visual effect of the decorative display apparatus 100.

In an alternate embodiment of a densely packed configuration 55 of the present invention, the front support member 10 may comprises a plurality of first modular units removably attached to each adjacent first modular unit within the first plane wherein each of the plurality of first modular units comprises a strip of support material defining a first aperture 20 of said plurality of first apertures 20. Likewise, the rear support member 15 may comprises a plurality of second modular units removably attached to each adjacent second modular unit within said second plane wherein each of the plurality of second modular units comprises a strip of support material defining a second aperture 25 of said plurality of second apertures 25. Each modular unit may comprise releasable connection points about its circumference or periphery for creating a secure connection with a plurality of adjacent modular units within the same plane. In such an embodiment, each consumer could create any specific shape or configuration of the front support member 10 as desired by removably attaching adjacent first modular units together within a first plane. In a similar manner, the consumer may construct an analogous rear support member 15 from a plurality of second modular units that are removable attachable within a second plane. At least one stabilization body 40 and optionally a base member 35 may then be used to maintain the front support member 10 in a parallel relationship with the second support member 15.

In use, as depicted in FIGS. 1, 2, 5, and 6, a front support member 10 may support a first end of an illumination housing 30 and a rear support member 15 may support a second end of the illumination housing 30. Each illumination housing 30 may be disposed within and extend through a respective first aperture 20 in the front support member 10 and a respective second aperture 25 in the rear support member 15. The respective first apertures 20 and second apertures 25 may be axially aligned so as to maintain each illumination housing 30 in a generally horizontal position. At least one stabilization body 40 may maintain the front support member 10 in a position parallel to the rear support member 15. The at least one stabilization body 30 may be secured to the front support member 10 and/or rear support member 15, respectively, by at least one fastener member 45 which may include but is not limited to nuts, bolts, and any other fasteners known within the art.

As depicted in FIGS. 2 and 6, a lighting configuration 65 may provide at least one light source 60 to each of the plurality of illumination housings 30. The lighting configuration 65 and at least one light source 60 may enter the illumination housing 30 at the one point of entry 31 that is disposed adjacent the second side 17 of the rear support member 15. Each of the at least one light sources 60 may then extend though a respective second aperture 25 in which the illumination housing 30 is disposed. In distributing at least one light source 60 to each of the plurality of illumination housings 30, the lighting configuration 65 may undertake any number of unique configurations disposed along the second side 17 of the rear support member 15, including that shown in FIG. 6. To assist a consumer in establishing an efficient lighting configuration 65, the second side 17 of the rear support member 15 may have indicia disposed thereon to guide the consumer along an effective and/or efficient path (see FIG. 6). A light source retention means may be employed at the one point of entry 31 on each of the plurality of illumination housings 30 as a means to reduce the possibility of accidental removal of each of the at least one light sources 60 from their respective illumination housings 30.

Additionally, creative embellishments may be added to the decorative display apparatus 100 of the present invention. Such embellishments may include, but are not limited to the use of fabric, sequins, buttons, pins, hanging of decorative items from the illumination housings 30 or the first side 11 of the front support member 10, and the like. Such embellishments may be used to supplement the visual display of the present invention and may be disposed about the front support member 10, illumination housing 30, at least one fastener member 45, and base member 35.

The decorative display apparatus 100 may be made available to consumers in a variety of formats. First, pre-made standards may be sold to consumers for popular holidays and/or any such events. Second, custom-shaped front support members 10 and rear support members 15 may be pre-made into shape-based displays or sold individually or in groups to allow consumers to create their own custom-shaped decorative display apparatus 100. Third, craft kits including directions for consumer creation of decorative displays 100 for everyday and/or holiday use may be provided. Fourth, without employing a front support member 10 or a rear support member 15, an illumination housing 30 of the present invention may be transformed into an individual ornamental display, such as a Christmas ornament, having at least one light source 60 therein. All of the embodiments described in this application may further comprise the optional features including, but not limited to, lights disposed within the plurality of illumination housings 30, further embellishments such as those described above, and features allowing consumers to hang decorative items from any and all elements of the decorative display apparatus 100.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A decorative display apparatus comprising:
a front support member having a first side and a second side, said front support member exists generally in a first plane and further comprises a plurality of first apertures extending through said front support member;
a rear support member having a first side and a second side, said rear support member exists generally in a second plane and further comprises a plurality of second apertures extending through said rear support member, wherein said plurality of first apertures are equal in number to said plurality of second apertures; and
at least one stabilization body for maintaining said first plane of said front support member in a position parallel to said second plane of said rear support member, wherein said second side of said first support member is disposed in a position facing said first side of said second support member and each of said plurality of second apertures is disposed in axial alignment, respectively, with one of said plurality of first apertures.

2. The decorative display apparatus of claim 1, further comprising:
a base member for maintaining said decorative display apparatus in a generally upright position, wherein said base member is in communication with both a lower portion of said front support member and a lower portion of said rear support member.

3. The decorative display apparatus of claim 1, further comprising:
at least one fastener member for securing said at least one stabilization body to said front support member or said rear support member.

4. The decorative display apparatus of claim 1, further comprising:
a plurality of illumination housings disposed within and extending between said plurality of first apertures and said plurality of second apertures, each of said plurality of illumination housings comprising only one point of entry wherein said one point of entry is disposed adjacent said second side of said rear support member allowing for access through one of said plurality of second apertures to said first side of said rear support member.

5. The decorative display apparatus of claim 4, wherein each of said plurality of illumination housings comprises a recyclable item wherein said recyclable item allows light to pass there through.

6. The decorative display apparatus of claim 5, wherein said recyclable item is selected from the group consisting of a plastic bottle, a glass bottle, a plastic container, and a can.

7. The decorative display apparatus of claim 4, wherein each of said plurality of illumination housings contains at least one light source that enters each of said plurality of illumination housing through said one point of entry.

8. The decorative display apparatus of claim 7, wherein said at least one light source is selected from the group consisting of light emitting diodes, rope lights and string lights.

9. The decorative display apparatus of claim 1, wherein said front support member and said rear support member are respectively constructed in a densely packed configuration.

10. The decorative display apparatus of claim 1, wherein said front support member and said rear support member are respectively constructed in a loosely packed configuration.

11. The decorative display apparatus of claim 1, wherein said front support member comprises a plurality of first modular units removably attached to each other in said first plane wherein each of said plurality of first modular units comprises a strip of support material defining one first aperture of said plurality of first apertures and said rear support member comprises a plurality of second modular units removably attached to each other in said second plane wherein each of said plurality of second modular units comprises a strip of support material defining one second aperture of said plurality of second apertures.

12. The decorative display apparatus of claim 1, wherein said front support member and said rear support member, respectively, comprise two or more component members removably connected to each other thereby allowing for more compact storage of said front support member and said rear support member when not in use.

13. The decorative display apparatus of claim 1, wherein said front support member and said rear support member, respectively, comprise one or more fold lines thereby allowing for more compact storage of said front support member and said rear support member when not in use.

14. A decorative display apparatus comprising:
a front support member having a first side and a second side, said front support member exists generally in a first plane and further comprises a plurality of first apertures extending through said front support member;
a rear support member having a first side and a second side, said rear support member exists generally in a second plane and further comprises a plurality of second apertures extending through said rear support member, wherein said plurality of first apertures are equal in number to said plurality of second apertures;
at least one stabilization body for maintaining said first plane of said front support member in a position parallel to said second plane of said rear support member, wherein said second side of said first support member is disposed in a position facing said first side of said second support member and each of said plurality of second apertures is disposed in axial alignment with one of said plurality of first apertures;
at least one fastener member for securing said at least one stabilization body to said front support member or said rear support member; and
a plurality of illumination housings disposed within and extending between said plurality of first apertures and said plurality of second apertures, each of said plurality of illumination housings comprises only one point of entry into each of said plurality of illumination housings wherein said one point of entry is disposed adjacent said second side of said rear support member allowing for access through one of said plurality of second apertures to said first side of said rear support member;
wherein each of said plurality of illumination housings contains at least one light source that enters each of said plurality of illumination housings through said one point of entry of each of said plurality of illumination housings.

15. The decorative display apparatus of claim 14, further comprising:
a base member for maintaining said decorative display apparatus in a generally upright position, wherein said base member is in communication with both a lower portion of said front support member and a lower portion of said rear support member.

16. The decorative display apparatus of claim 14, wherein each of said plurality of illumination housings comprises a recyclable item wherein said recyclable item allows light to pass there through.

17. The decorative display apparatus of claim 16, wherein said recyclable item is selected from the group consisting of a plastic bottle, a glass bottle, a plastic container, and a can.

18. The decorative display apparatus of claim 14, wherein said front support member and said rear support member, respectively, comprise two or more component members removably connected to each other thereby allowing for more compact storage of said front support member and said rear support member when not in use.

19. The decorative display apparatus of claim 14, wherein said front support member and said rear support member, respectively, comprise one or more fold lines thereby allowing for more compact storage of said front support member and said rear support member when not in use.

20. A decorative display apparatus comprising:
a front support member having a first side and a second side, said front support member exists generally in a first plane and further comprises a plurality of first apertures extending through said front support member;
a rear support member having a first side and a second side, said rear support member exists generally in a second plane and further comprises a plurality of second apertures extending through said rear support member, wherein said plurality of first apertures are equal in number to said plurality of second apertures;
at least one stabilization body for maintaining said first plane of said front support member in a position parallel to said second plane of said rear support member, wherein said second side of said first support member is disposed in a position facing said first side of said second support member and each of said plurality of second apertures is disposed in axial alignment with one of said plurality of first apertures;
at least one fastener member for securing said at least one stabilization body to said front support member or said rear support member; and
a plurality of illumination housings disposed within and extending between said plurality of first apertures and said plurality of second apertures, each of said plurality of illumination housings comprises only one point of entry into each of said plurality of illumination housings wherein said one point of entry is disposed adjacent said second side of said rear support member allowing for access through one of said plurality of second apertures to said first side of said rear support member, each of said plurality of illumination housings comprising a recyclable item wherein said recyclable item allows light to pass there through, said recyclable item is selected from the group consisting of a plastic bottle, a glass bottle, a plastic container, and a can;
at least one light source contained within each of said plurality of illumination housings, said at least one light source entering each of said plurality of illumination housings through said one point of entry of each of said plurality of illumination housings, said at least one light source is selected from the group consisting of light emitting diodes, rope lights and string lights.
